(19) United States
(12) Patent Application Publication
(10) Pub. No.: US 2024/0008094 A1
(43) Pub. Date: Jan. 4, 2024

(54) METHODS OF ADJUSTING AND SELF-STABILIZING THE RECEIVER SIDE IN THE FIFTH-GENERATION RADIO STATION

(71) Applicant: VIETTEL GROUP, Ha Noi City (VN)

(72) Inventors: Trung Tien Nguyen, Ha Noi City (VN); Xuan Hao Luong, Ha Noi City (VN); Truong Giang Le, Ha Noi City (VN); Van Hoan Duong, Ha Noi City (VN)

(73) Assignee: VIETTEL GROUP, Ha Noi City (VN)

(21) Appl. No.: 18/344,432

(22) Filed: Jun. 29, 2023

(30) Foreign Application Priority Data
Jun. 30, 2022 (VN) 1-2022-04127

(51) Int. Cl. H04W 74/08; H04W 24/08; H04B 17/318

(52) U.S. Cl. CPC H04W 74/0833; H04W 24/08; H04B 17/318

(57) ABSTRACT

A method of adjusting and self-stabilizing the receiver side in 5G including: initial synchronization set and the set of constructing parameters, collecting the initial defining phase value of the reference channel and data; Determine and evaluate the signal lag and the first crest string capacity on the PRACH (Physical Random Access Channel) offer the first assessment coefficient; Compare the first assessment coefficient to the adjustment requirement if greater than the adjustment threshold continues to process data and evaluate the detailed adjustment of the detailed level on the PUSCH (Physical Uplink Share Chanel) schedule a processing money, giving the second assessment coefficient. If less than the adjustment requirements perform the next step: from the above evaluation coefficients perform late compensation on the conversion card (transfer card-two-way data transfer department from BBU and RRU) and power on RRU with periodic or instant update time according to the adjustment rule.

### TECHNICAL FIELD

The invention refers to the methods of adjusting and self-stabilizing the receiver side in the fifth-generation radio station. Specifically, the method is mentioned in the fifth mobile network (5G network).

### TECHNICAL STATUS OF THE INVENTION

In general telecommunications systems and in new mobile networking network (NR—New Radio) 5G, the use of services, maintaining stability between user equipment (UE—User Equipment) and the original transceiver should be implemented synchronously, this synchronization needs to meet the requirements for the covered areas with narrow radius (Small Cell) and areas with wide radius (Macro cell).

The handling task of GNB (Next Generation Node B—the new generation of the original tape support station supports 5G technology) is to decode the correct access signal of UE, and determine the UE signal delay to synchronize again receiver side. The processing block is the upgrade data channel that needs to be processed in GNB and continue to other data channels processed. In addition, it is continuously processed in the process of running GNB to continuously search for UEs that want to access the network or re-synchronize. The monitoring of environmental changes as well as corrections to compensate for all domain signal deviations at remote radio data transmission devices (RRU—Remote Radio Unit) are transformed immediately Regarding the frequency domain and then transferring to the baseband data transmission device (BBU—Baseband Unit).

Currently, 5G network technology developers in the world also have different treatments. For some telecommunications firms, such as Nokia, Ericsson, often choose the passive adjustment method of the path (port) before deploying by emitting reference signals and measuring the deviation between the paths, then giving the initial adjustment number, the handling way to ensure the processing at RRU. For some other brands such as Intel's Flexran or Xilinx, Huawei uses a separate hardware set for DFT (Discrete Fourier Transform) for reference signals at RRU, which also separates the processing part. High load on a specialized hardware to perform this processing (DFT pre-filtration process for time domain). However, most of the above solutions have some disadvantages as follows:
The time domain data is pushed to BBU with a large capacity, and is only interested in processing RRU before sending it out, resulting in the inability to adjust and stabilize in real time.
Consumption of resources and high initial product costs due to very large equipment requirements with hardware processing accuracy.
The accuracy and the wrong decoding rate depend on the passive stability of the device, unable to compensate for errors and fluctuations over time.

### TECHNICAL NATURE OF THE INVENTION

Therefore, the purpose of the invention is to create a method of adjusting and self-stabilizing the receiver side in 5G station, solving the problem of delay and deviations with the user data in the network in real time, thereby guaranteeing the quality of data receiver and decoding accurate signals, helping to optimize the active system processing resources.

To achieve the above goal, the patent proposes the method including:

Step 1: Set the initial synchronization and the initial constructor, collect the initial defining phase value of the reference channel and the data.

Step 2: Determine the first assessment coefficient via PRACH. At this step, determining and evaluating the signal delay and the first crest chain on the PRACH (Physical Random Access Channel).

Step 3: Compare adaptation and find the second assessment coefficient via PUSCH channel. At this step, from the first assessment coefficient compares with the adjustment requirement if greater than the adjustment threshold, continue to process data and evaluate the detailed adjustment of the detailed level on the PUSCH data channel (Physical Uplink Share Chanel) Scheduling for pre-processing, giving the second assessment coefficient. If smaller than the adjustment requirements continue to implement step 4.

Step 4: Application of late compensation coefficient and power balance on two-way conversion BBU and RRU. At this step, from the above evaluation coefficients perform late compensation on the conversion card (transfer card—a way data transfer unit from BBU and RRU) and power on RRU with periodic or instantaneous updates according to the adjustment rule.

### BRIEF DESCRIPTION OF DRAWINGS

FIG. 1 is a drawing of a block diagram describing the data flow of communication components on gNodeB, performed in step 1 of the invention;

FIG. 2 is a drawing of a block diagram describing the division of PRACH channel and processing input, performing in step 2 of the invention;

FIG. 3 is a drawing of a block diagram describing the determination of power and latency on the PRACH, performed in step 2 of the invention;

FIG. 4 is a drawing of a block diagram that determines the value of SNR (signal to noise ratio), NI (noise and interference) and TO (timing offset) on PUSCH, performed in step 3 of the invention;

FIG. 5 is a diagram drawing description block determines the value of the first assessment coefficient, performed in step 3 of the patent;

FIG. 6 is a drawing shape of a block diagram that determines the performance of data channel use, performed in step 3 of the invention;

FIG. 7 is a drawing shape of a diagram described to determine the adjustment coefficient, performed in step 3 of the invention;

FIG. 8 is a drawing shape of a diagram described to determine the second assessment coefficient, performed in step 3 of the invention;

FIG. 9 is a drawing of a diagram of a description that determines the update delay on the transfer card (transfer card) on each line, performed in step 4 of the invention;

FIG. 10 is a drawing shape of a diagram that determines the determination of the power deviation on each line to be updated, performed in step 4 of the invention;

FIG. 11 is a drawing of a diagram of a determinant and update to be adjusted periodically or immediately, performing in step 4 of the invention.

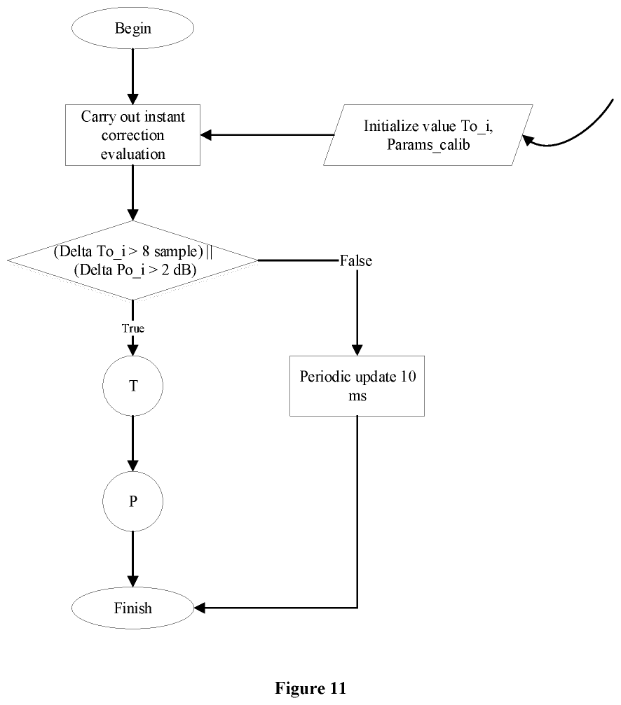

### DETAILED DESCRIPTION OF THE INVENTION

In the optimal system of gNodeB (Next Generation Node B—the new generation of the original taping station supports 5G technology), the method of adjusting and self -stabilizing the receiver in 5G, solving the problem of delay and delayed problems and deviation in user data in real-time network, thereby ensuring the quality of data collection and decoding accurate signals, helping to optimize the active system processing resources. The method includes the following details:

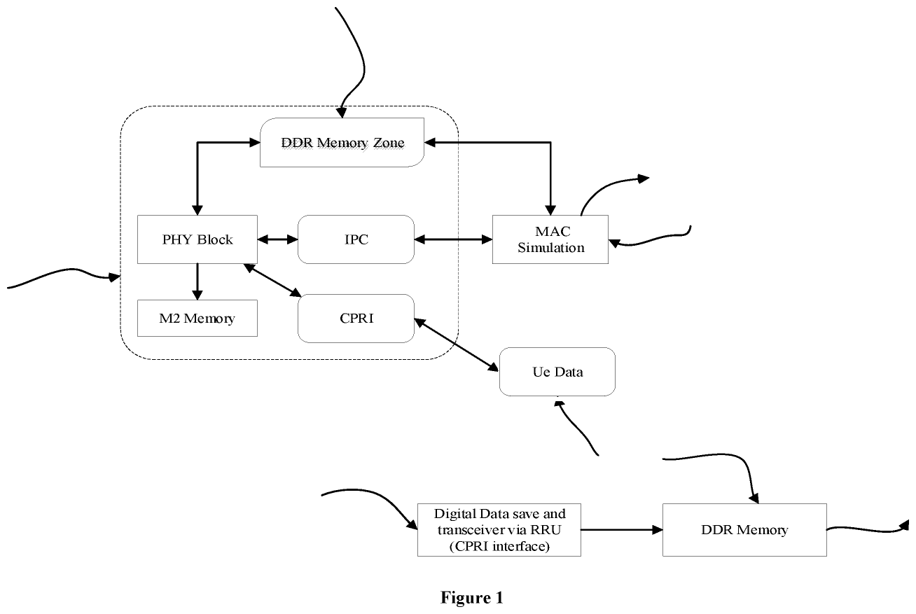

Step 1: Set the initial synchronization and the initial constructor, collect the initial defining phase value of the reference channel and the data. As follows:
ai) initialization of the system is the input for processing with the number of input antennas depending on the hardware capacity with the deployment configuration with a maximum configuration of eight revenues and classifications data format of PRACH and PUSCH physical channels. The initialization of the system is reflected in the detailed description of the data flow of communication components on gNodeB and the operation of the root processing block on the basic band processing block (BBC—BASEBAND CARD) including the processor. Physics class and environmental access control layer (MAC—Media Access Control) combine data sent from UE or Random access memory mode with double transmission speed (DDR—Double Data Rate Random Access Memory) as shown in FIG. 1. The steps are as follows:
Make data exchange between UE and gNodeb after lowering and converting to numerical forms through the common radio interface block (CPRI—Common Public Radio Interface).
The physical layer processing block will get data on the CPRI data storage area to decode and transfer the results after decoding through the process of communication between processes (IPC—Inter-Process Communication) into the memory area General access.
On this general access memory area, the MAC processor will get the decoding information to send the scheduling information to the physical processor.
Perform data after decoding and send information back to MAC.
   aii) Collect the initial determined value of the channel to refer to the role of the PRACH channel periodically and the PUSCH data channel.
Through the initial data determination step of the PRACH with long or short format configurations, performing data separation and removing CP is the prefix-cyclixic data of the PRACH.

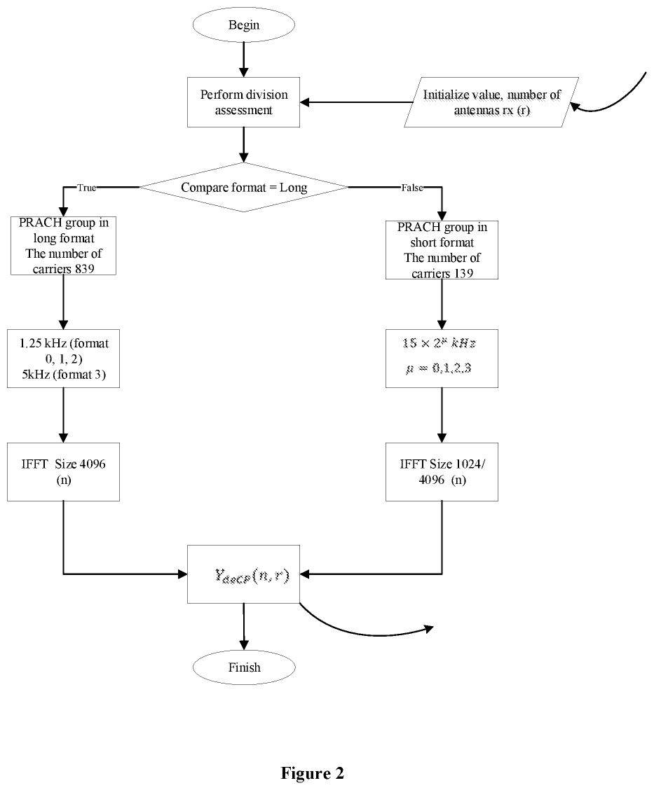

Reference from FIG. 2 describes the PRACH channel data processing flow. In which, the time domain data is included in the following blocks:
CP removal block: The function of removing CP parts on the frequency domain to obtain data;
DFT block: The discrete Fourier conversion function is a periodic signal of the frequency domain, and then separates the PRACH signal on the frequency domain.

In terms of time structure, NR PRACH, a group of PRACH characters repeated n times over time, paired with the repetition of the prefix (CP). The length of the CP and the number of repetitions is specified for each format. Each of the main signal segments (the marking S) is born from the Zadoff chain. To decode the PRACH signal, the first step is to extract this S signal on the time domain and bring it to the frequency domain. Time resources—Frequency for NR PRACH access are called processing groups. In a covered area, the PRACH transmission is a cycle in a collection of slots. The collection of these slots is called the PRACH slots. These slots are repeated on time domain according to a certain configuration. In each slot, there are many PRACH players (PRACH group processing) divided by frequency domain.

Y_{deCP}(n, r)

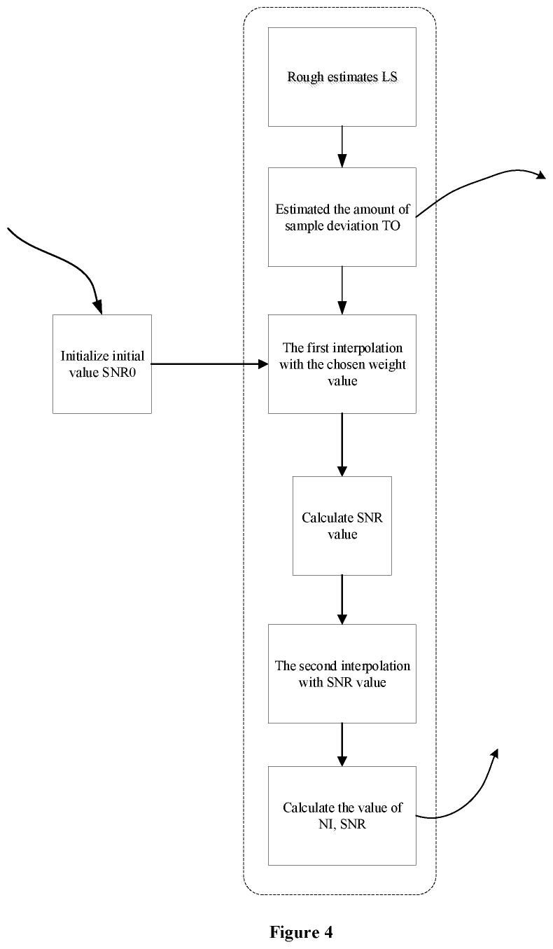

FIG. 4 reference for PUSCH channel processing part:
With PUSCH channel data made estimated by LS algorithm (Least Square-Minimum Square):
   The raw channel estimate is based on the LS algorithm:

Ĥ_{LS}(k, r)=X^{H}Y
in which X is the DMRS chain known in advance on both the transmitter and the receiver, Y is the signal obtained at the DMRS mapping positions in the resource grid;
Estimated sample deviation on the time domain:
   Determine the phase deviation between the sub carriers in the same DMRS character:

$$phase ( r ) = {\sum }_{k = 0}^{K - 2} {\hat{H}}_{LS} ( k , r ) {( {\hat{H}}_{LS} ( k + 2 , r ) )}^{H}$$

in which K is the number of sub -carriers with DMRS characters;
Convert phase deviations to samples deviation on large time domain:

$${TO}_{est} = \frac{angle ( {\sum }_{r = 0}^{R - 1} phase ( r ) ) * {N}_{FFT}}{2 * π * m}$$

in which R is the number of antennas, N_{FFT} is the length FFT, angle is the atan2 function, and m is the distance between the two sub-carriers used to calculate the phase deviation;
m different depends on the type of DMRS mapping, specific
   +DMRS Type 1: m=4, phase is calculated between sub carrier 1 and 5, 3 and 7, . . .
   +DMRS Type 2: m=6, phase is calculated between sub carrier 1 and 7, 2 and 8, . . .
The W-interpolation matrix is determined by the following formula:

W=Φ_{ĤH}*Φ_{ĤĤ}⁻¹
Correlation with the interpolation of the PUSCH channel, we have:
   Ĥ is the channel estimate based on the DMRS reference signal;
   H is an estimate of channel transmission to PUSCH channel data;
   Φ_{ĤH} is the cross-correlation matrix between the transmission channel for data and transmission channels of the DMRS reference signal;
   Φ_{ĤĤ} is the appropriate matrix of the transmission channel of the DMRS reference signal.
Accordingly, Φ_{ĤĤ} consists of cross-correlation weights θ(k, l) between the transmission channel for data at the position of the carrier k, the character l and the transmission channel of the DMRS reference signal at the carrier k′, l′ character, calculated by the SINC function as follows:

θ(k, l)=sinc(2f_{D}_{ₘₐₓ}T_{S}(l−l′)·sinc(2τₘₐₓμ(k−k′))
in which τₘₐₓ is the maximum delay of the transmission channel (S);
μ is the paragraph distance (Hz);
f_{D}_{ₘₐₓ} is the maximum Doppler translation of the transmission channel (Hz);
Tₛ is a sampling cycle;
k−k′ is the carrier distance between data and DMRS;
l−l′ is the distance between data and DMRS;
The formula for calculating Φ_{ĤĤ} is the MMSE matrix including the appropriate matrix and signal parameters on SNR noise:

$$Φ ( {k}^{′} , {l}^{′} ) = \frac{1}{S N R} \cdot I + θ ( {k}^{′} , {l}^{′} )$$

where I is the unit matrix. SNR=SNR₀=30 is the starting SNR value used to interpolate the first transmission channel, then redefine the SNR value and interpolate the second-time channel.
Implement estimate of transmission environmental indicators:
   Received signal intensity index p (Received signal strength indication—RSSI):

X=X_{dmrs}(k, l)*Ĥ_{RS}(k′, l′)

p=mean(X·X^{H})
The noise index σ (noise plus interference—ni):

δ(k, l)=Y_{RS}(k, l)−p

σ=mean(δ·δ^{H})
The signal ratio index on SNR noise:

SNR=p/σ

Step 2: Determine the first assessment coefficient via PRACH.

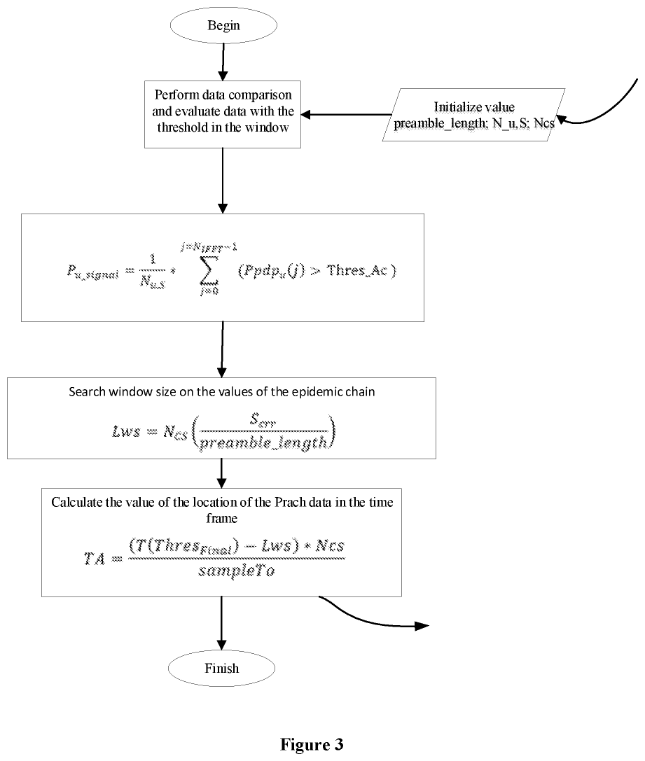

At this step, determining and evaluating the signal delay and the first preamble chain on the PRACH (Physical Random Access Channel). Specifically:
bi) Determine the value of the signal latency and the crest of the PRACH channel data chain based on the initial determination in step 1. This determination is reference FIG. 3.
Determine the PRACH signal latency by comparing the defined signal and the reference signal after eliminating the fake signal (Ta). With a window signal, it is possible to calculate the deviation value or the signal delay based on the number of samples to the Thres_final value in the window.

$$T A = \frac{( T ( T h r e {s}_{F i n a l} ) - L w s ) * N c s}{s a m p l e T o}$$

inside:
T(Thres_{Final} is the top search location in the Thres_Ac search window with the corresponding IFFT window;
Ncs is the corresponding value of the original chain (root) search;
sampleTo is the number of samples calculated in the format, bandwidth and μ of PRACH;
Determine the power string capacity based on average signal power:

$${P}_{u \_ avg} = \frac{1}{{N}_{IFFT}} * {\sum }_{j = 0}^{j = {N}_{IFFT} - 1} P p d {p}_{u} ( j )$$

inside:
P_{u_avg} is the average PDP value for each original chain with the corresponding IFFT window;
N_{IFFT} is the length of the IFFT window;
Ppdpᵤ(n) is the data determining the average power of the antenna received with the size of the window j (based on the square of the signal amplitude);
bii) Review and adjust the first time for PRACH data obtained.
Based on the results of PRACH, the signaling crest value (preamble) and

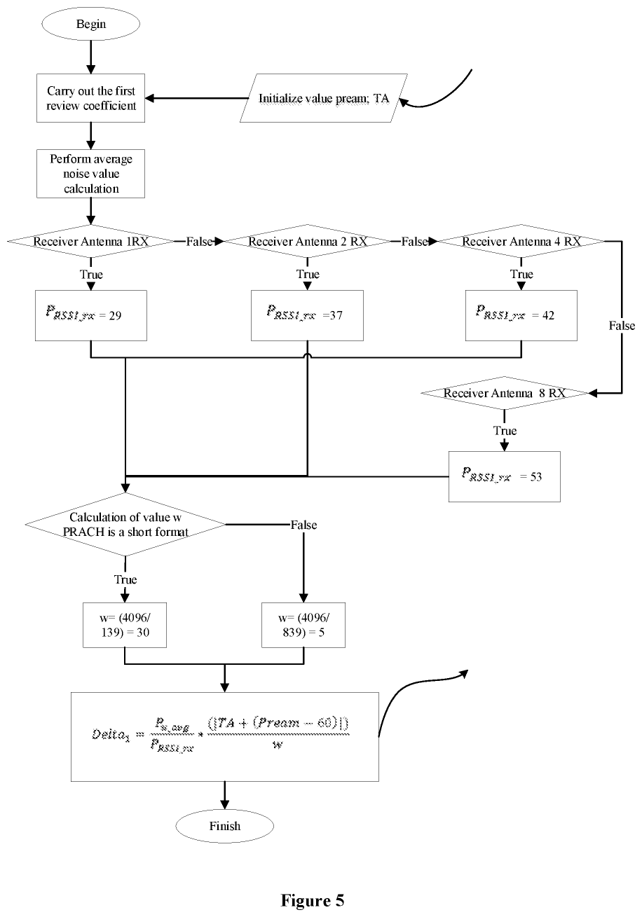

P_{u_avg} power and the latency we are determined as above applied to the system dynamic configuration:
PRACH configuration currently has two formats:
   With short-term sets w=(4096/139)=30;
   With long nails w=(4096/839)=5.
The adjustment rules are as follows:
   Carry out the modulation of MCS (modulation scheme—Method of encryption in the processing) downlink (downlink) on the value equal to 18 and the number of generated resources is RB (Resource Block—Resources block)=200. direction upwards (Uplink) MCS 1 and RB=90; They will be proportional to the system bandwidth.
   Fix Zeroconfig configuration from value 3 to 2;
   Look up the standard table 38.211 according to 3GPP document Chapter 6, the value of the original physical value (root physical) corresponds to the original chain value (root sequence) at. For example, it is 32.
   Take the 139 chain residue for the configuration that is using two chains, each string of four windows (with configuration 2), the residual part is 3, the last part of 19;
   Choose the smallest value divisible by 19*4=76;
   If the above balance is 2, then the volatile value is 40. If the above balance is 1, the volatile value is 30=>so choose the value of 76−40=36 with the balance 2 and 76−30=46 with balance 1;
   Change SsbPower configuration if it is 2, then reduce two units, else 1 will reduces 1 unit.
biii) Determine the first evaluation coefficient based on the bii);
Implement UE synchronous and determine coefficient value. The first assessment, reference from FIG. 5 and interpret the formula as below:

$$D e l t {a}_{1} = \frac{{P}_{u \_ avg}}{{P}_{RSSI \_ rx}} * \frac{( \vert TA + ( P r e a m - 60 ) \vert )}{w}$$

inside:
P_{u_avg} is the average PDP value for each root chain with the corresponding IFFT window;
P_{RSSI_rx} is the maximum average interference capacity according to the number of antennas received (1 rx=29; 2 rx=37; 4 rx=42; 8 rx=53);
Pream is the decoding crest value (preamble);
w is the value of the PRACH format above;
Delta₁ is the first evaluation coefficient.

Step 3: Compare adaptation and find the second assessment coefficient via PUSCH channel.

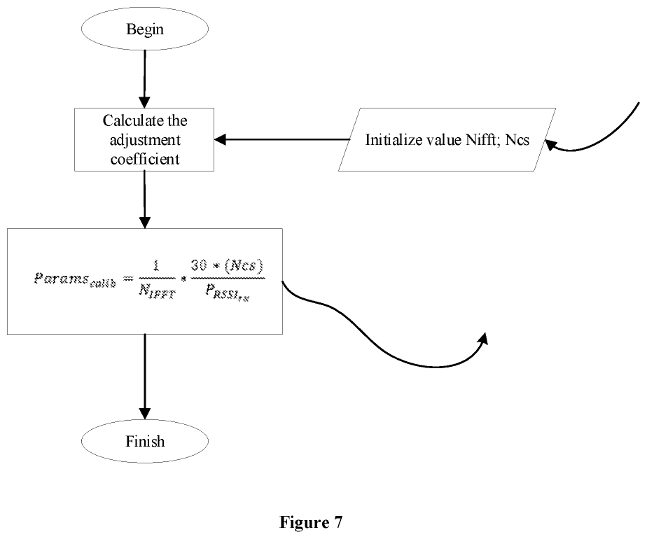

At this step, from the first assessment coefficient compared to the adjustment requirement if greater than the adjustment threshold continues to process data and evaluate the detailed adjustment of the detailed level on PUSCH (Physical UPLink Share Chanel) schedule a processing schedule, giving the second assessment coefficient. If smaller than the adjustment requirements continue to implement step 4.
ci) review comparison of the first evaluation coefficient Delta₁ and the adjustment coefficient (reference from FIG. 7). The adjustment coefficient is calculated by the following formula:

$$P a r a m {s}_{c a l i b} = \frac{1}{{N}_{IFFT}} * \frac{30 * ( N c s )}{{P}_{{RSSI}_{rx}}}$$

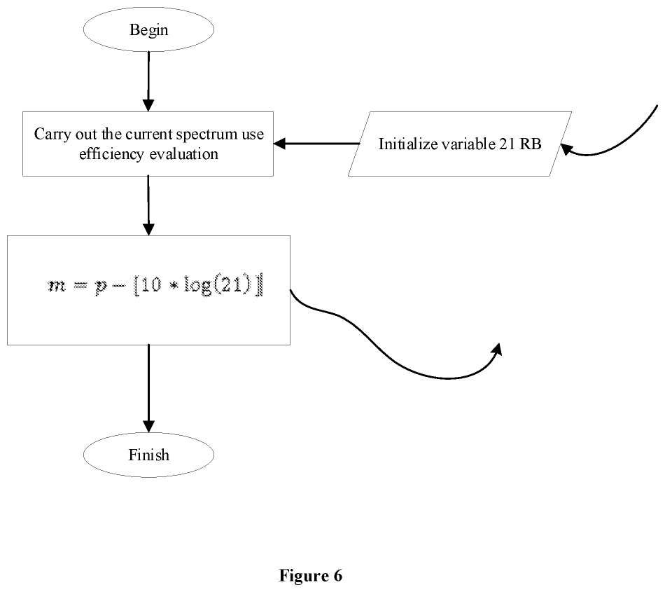

inside:
N_{IFFT} is the length of the IFFT window;
P_{RSSI_rx} is the maximum average interference capacity according to the number of antennas received (1 rx=29; 2 rx=37; 4 rx=42; 8 rx=53);
Ncs is the corresponding value of the location of the search root chain;
N_{IFFT} is the length of the IFFT window;
Params_{calib} is the adjustment coefficient.
If the value Delta₁ is smaller than the value Params_{calib}, continue to perform step 4;
If the value Delta₁ is greater than the value Params_{calib}, then perform the following adjustment:
Based on PUSCH channel collecting and determining the signal ratio value on SNR noise. Received signal intensity index (Received signal strength indication—RSSI); The noise index σ (Noise Plus Interference (NI) and the number of samples deviated on the large time domain.
Using periodical data trees periodically, in which the road data up with the number of RB resources is 21, calculating the existing use ratio compared to the effectiveness to evaluate the current spectrum performance, greed Projection FIG. 6:

m=p−[10*log(21)]

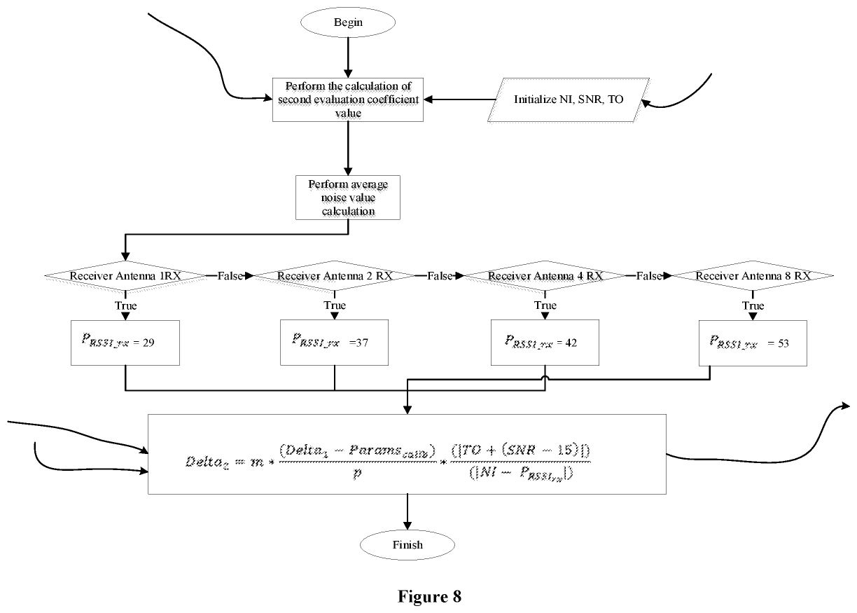

inside:
p is the signal intensity value of the PUSCH channel;
m is the current spectrum performance.
cii) Determine the second assessment coefficient based on the CI part);
Implement UE synchronization and determine the value of the second assessment coefficient (reference from FIG. 8) and according to the following formula:

$${Delta}_{2} = m * \frac{( {Delta}_{1} - P a r a m {s}_{c a l i b} )}{p} * \frac{( \vert TO + ( S N R - 15 ) \vert )}{( \vert NI - {P}_{{RSSI}_{rx}} \vert )}$$

inside:
p is the signal intensity value of the PUSCH channel;
P_{RSSI_rx} is the maximum average interference capacity according to the number of antennas received (1 rx=29; 2 rx=37; 4 rx=42; 8 rx=53);
TO is the value of the deviation on time domain;
SNR is a signal value on noise;
NI is the value noise and interference of PUSCH;
Delta₁ is the first evaluation coefficient;
Delta₂ is the second evaluation coefficient.

Step 4: Application of late compensation coefficient and power balance on two-way conversion BBU and RRU.

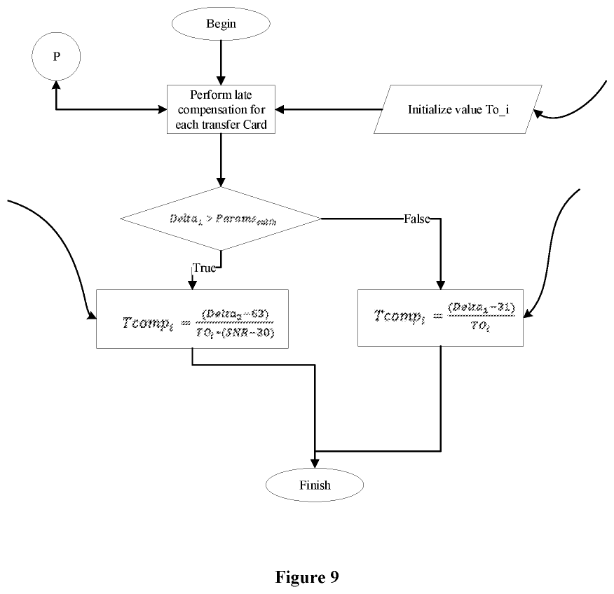

From the above evaluation coefficients perform late compensation on conversion cards (transfer cards—data transfer parts from BBU and RRU) and power on RRU with periodic or instant updates according to the rule adjust.
di) Perform delayed compensation on conversion cards (transfer cards) based on evaluation coefficient Delta₂ and Delta₁.
The number of roads on the transfercard corresponds to the amount of path collection with the requirements of the updated lines according to the update cycle of 10 ms. Therefore, the value is compensated on each of these lines, reference FIG. 9, and will satisfy the following formula:

$$T c o m {p}_{i} = \frac{( {Delta}_{2} - 63 )}{T {O}_{i} * ( S N R - 30 )} n {e}^{\hat{} ′} u {Delta}_{1} > {Params}_{c a l i b}$$

$${Tcomp}_{i} = \frac{( {Delta}_{1} - 31 )}{{TO}_{i}} n {e}^{\hat{} ′} u {Delta}_{1} < {Params}_{c a l i b}$$

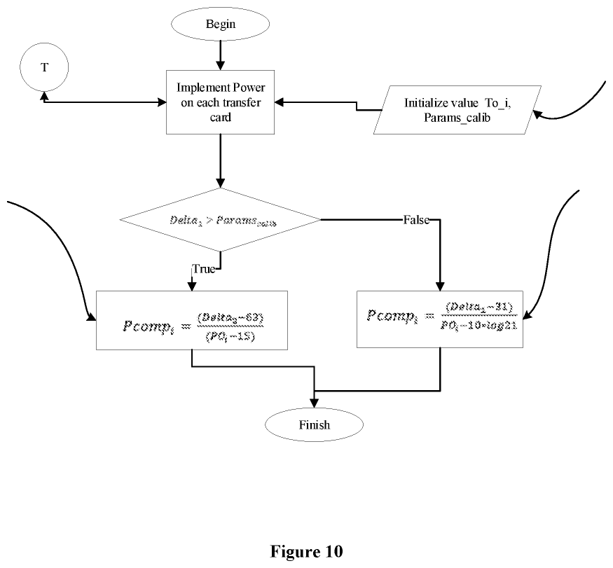

inside:
Tcompᵢ is the delayed compensation value for the first revenue antenna line;
TOᵢ is the value of the prototype deviation of each path of the path of initialization;
SNR is a signal value on noise;
NI is the value of the calculated noise power of PUSCH;
Delta₁ is the first evaluation coefficient;
Delta₂ is the second evaluation coefficient.
dii) Perform capacity compensation for each real-time collection line (reference FIG. 10) with a update cycle of 10 ms.

$${Pcomp}_{i} = \frac{( {Delta}_{2} - 63 )}{( {PO}_{i} - 15 )} n {e}^{\hat{} ′} u {Delta}_{1} > {Params}_{c a l i b}$$

$${Pcomp}_{i} = \frac{( {Delta}_{1} - 31 )}{{PO}_{i} - 10 * log 21} n {e}^{\hat{} ′} u {Delta}_{1} < {Params}_{c a l i b}$$

inside:
Pcompᵢ is the power offset value for the ith revenue antenna line;
POᵢ is the value of the prototype of the power line for the original road according to the initialization;
SNR is a signal value on noise;
NI is the value of the calculated noise power of PUSCH;
Delta₁ is the first evaluation coefficient;
Delta₂ is the second evaluation coefficient.
diii) Perform transfercard and Power Card for each receiver as required instantaneous if the value appears TOᵢ between the line is more than 8 units or the value POᵢ between each the receiver is more than 2 dB. Figure reference 11.
For delay, it will follow the defined item formula for di) for transfercard.
For capacity will follow the determination formula in dii) for transfer card compensation value.

At the end of Step 4, the invention offers the desired phase head value and the capacity at the data collected at the connection heads is similar, the system synchronizes in a broadcast in real time.

### Example of the Invention

In fact, the system is established by the method of the invention that has been applied in the laboratory and implemented in reality with the 5G radio transceiver.

Currently, the system is actually installed at the electronic laboratory under the GNodeB project, the order of establishing and applying the patent method is described as follows as follows. The actual system setup includes the establishment of the RRU/BBU system where the user data emulator sets and the multi-line emulator add noise to evaluate the signal decoding capacity. Perform system operation for a long time and create fluctuations to evaluate adjustment changes and stabilize the system. Evaluation of the best response cycle that the system achieved is 45 ms with the biggest delayed fluctuation of 150 units and the maximum power deviation of 3.5 dB. With the response of the inventing method of determining the recovery to the level of 2 deviations and the difference capacity is 0.3 dB. For not using the method of system invention, it will have an unstable problem with a large range of delayed vibration from 100-150 units and deviation between 2-3 dB receiver.

### The Benefits Achieved by the Invention

The system is set by invention method is to create a method capable of adjusting and stabilizing the receiver in 5 g, solving the problem of delay and deviations in the user data in the network by time by time. Thereby ensuring the quality of data collection and decoding accurate signals, helping to optimize the active system processing resources.

1. Method of adjusting and self-stabilizing a receiver side in a fifth-generation radio station, including:
Step 1: Establish initial synchronization and initial constructor: collect an initial defining phase value of a reference channel and data;
Step 2: Determine a first assessment coefficient via PRACH channel; at this step, determining and evaluating a signal delay and the first crest chain on a PRACH Physics Channel (Physical Random Access Channel):
determine the PRACH signal latency by comparing the defining signal and the reference signal after eliminating a fake signal (Ta); with a window signal, calculate a deviation value or a signal delay based on a number of samples calculating a thres_final value in the window:
$$T A = \frac{( T ( T h r e {s}_{F i n a l} ) - L w s ) * N c s}{s a m p l e T o}$$
inside:
T(Thres_{Final})is the top search location in the Thres_Ac search window with a corresponding IFFT window;
Ncs is the corresponding value of an original chain (root) search;
sampleTo is the number of samples calculated in the format, bandwidth and μ of PRACH;
determine a power string capacity based on average signal power:
$${P}_{u \_ avg} = \frac{1}{{N}_{IFFT}} * {\sum }_{j = 0}^{j = {N}_{IFFT} - 1} P p d {p}_{u} ( j )$$
inside:
P_{u_avg} is the average PDP value for each original chain with the corresponding IFFT window;
N_{IFFT} is the length of the IFFT window;
Ppdpᵤ(n) is the data determining the average power of the antenna received with the size of the window j (based on the square of the signal amplitude);
review and adjust the first time for the obtained PRACH data:
based on the results of PRACH, the signaling crest value (preamble) and P_{u_avg} power and the latency TA which are determined as above applied to the system dynamic configuration:
PRACH configuration currently has two formats:
with short-term sets w=(4096/139)=30;
with long nails w=(4096/839)=5;
adjustment rules are as follows:
carry out the modulation of MCS (modulation scheme—the modulation method) downlink (downlink) in terms of value equal to 18 and the number of generated resources is RB (Resource Block—Natural Resources block)=200; MCS MCS (Uplink) on 1 and RB=90; they will be proportional to the system bandwidth;
fix Zeroconfig configuration from value 3 to 2;
look up standard table 38.211 according to 3GPP document chapter 6, original physical value corresponding to the original chain value at; the example is 32 density is 17; take ⅔ residual 2 units;
take the residue of the 139 chain for the configuration that is using two chains, each string of four windows (with configuration 2), the residual part is 3, the last part of 19;
choose the smallest value divisible by 19*4=76;
if the above balance is 2, then the volatile value is 40; If the above balance is 1, then the volatile value is 30=>So choose the value of 76−40=36 with a balance 2 and 76−30=46 with balance 1;
change SSBPower configuration if it is 2, then reduce two units, else 1 will reduces 1 unit;
determine the first assessment coefficient based on the previous section; implement UE synchronization and determine the value of evaluation and interpretation of formulas as below:
$${Delta}_{1} = \frac{{P}_{u \_ avg}}{{P}_{RSSI \_ rx}} * \frac{( \vert TA + ( P r e a m - 60 ) \vert )}{w}$$
inside:
P_{u_avg} is the average PDP value for each root chain with the corresponding IFFT window;
P_{RSSI_rx} is the largest average interference with the number of antennas in (1 rx=29; 2 rx=37; 4 rx=42; 8 rx=53);
Pream is the decoding crest value;
w is the value of the PRACH format above;
Delta₁ is the first evaluation coefficient;
Step 3: compare adaptation and find the second assessment coefficient via PUSCH channel; at this step, from the first assessment coefficient compared to the adjustment requirement if greater than the adjustment threshold continues to process data and evaluate the detailed adjustment of the detailed level on the PUSCH data channel schedule the processing money, giving the second assessment coefficient, if smaller than the adjustment requirements continue to perform the next step; specific:
comparison of the first evaluation coefficient Delta₁ and the adjustment coefficient, the adjustment coefficient is calculated according to the following formula:
$$P a r a m {s}_{c a l i b} = \frac{1}{{N}_{IFFT}} * \frac{30 * ( N c s )}{{P}_{{RSSI}_{rx}}}$$
inside:
P_{RSSI_rx} is the maximum average interference capacity according to the number of antennas received (1 rx=29; 2 rx=37; 4 rx=42; 8 rx=53);
Ncs is the corresponding value of the location of the search root chain;
N_{IFFT} is the length of the IFFT window;
Params_{calib} is the adjustment coefficient;
if the value Delta₁ is smaller than the value Params_{calib}, continue to perform step 4;
if the value Delta₁ is greater than the value Params_{calib}, then perform the following adjustment:
based on PUSCH channel collecting and determining the signal ratio value on SNR noise; Received signal intensity index p (Received signal strength indication—RSSI); The noise index σ (Noise Plus Interference (Ni) and the number of samples deviated on the large time domain;
use the periodic area data tree in which the receiver data with the number of RB resources is 21 calculating the existing use ratio compared to the effective effect to evaluate the current spectrum performance:
m=p−[10*log(21)]
inside:
p is the signal intensity value of the PUSCH channel;
m is the current spectrum performance;
determine the second evaluation coefficient
implement UE synchronization and determine the value of the second and according to the following formula:
$${Delta}_{2} = m * \frac{( {Delta}_{1} - P a r a m {s}_{c a l i b} )}{p} * \frac{( \vert TO + ( S N R - 15 ) \vert )}{( \vert NI - {P}_{{RSSI}_{rx}} \vert )}$$
inside:
p is the signal intensity value of the PUSCH channel;
P_{RSSI_rx} is the maximum average interference capacity according to the number of antennas received (1 rx=29; 2 rx=37; 4 rx=42; 8 rx=53);
TO is the value of the mi mi mi mi mi;
SNR is a signal value on noise;
NI is the value value of PUSCH;
Delta₁ is the first evaluation coefficient;
Delta₂ is the second evaluation coefficient;
Step 4: application of late compensation coefficient and power balance on two-way conversion BBU and RRRU; at this step, from the above evaluation coefficients perform late compensation on the conversion card (transfer card—data transfer unit from BBU and RRU) and power on RRU with periodic or instantaneous updates according to the adjustment rule; specific:
perform late compensation on transfer card based on evaluation coefficient Delta₂ and Delta₁:
the number of lane on the transfercard corresponds to the amount of receiver path with the requirements of the updated path according to the update cycle of 10 ms; therefore, the value is compensated on each of these lines and will satisfy the formula (1) following:
$$Tcom {p}_{i} = \frac{( {Delta}_{2} - 63 )}{T {O}_{i} * ( S N R - 30 )} n {e}^{\hat{} ′} u {Delta}_{1} > {Params}_{c a l i b}$$
$${Tcomp}_{i} = \frac{( {Delta}_{1} - 31 )}{{TO}_{i}} n {e}^{\hat{} ′} u {Delta}_{1} < {Params}_{c a l i b}$$
inside:
Tcompᵢ is the delayed compensation value for the first revenue antenna line;
TOᵢ is the value of the prototype deviation of each path of the path of initialization;
SNR is a signal value on noise;
NI is the value of the calculated noise power of PUSCH;
Delta₁ is the first evaluation coefficient;
Delta₂ is the second evaluation coefficient;
perform capacity compensation for each real-time collection line with the update cycle of 10 ms according to the following formula (2):
$${Pcomp}_{i} = \frac{( {Delta}_{2} - 63 )}{( {PO}_{i} - 15 )} n {e}^{\hat{} ′} u {Delta}_{1} > {Params}_{c a l i b}$$
$${Pcomp}_{i} = \frac{( {Delta}_{1} - 31 )}{{PO}_{i} - 10 * log 21} n {e}^{\hat{} ′} u {Delta}_{1} < {Params}_{c a l i b}$$
inside:
Pcompᵢ is the power offset value for the ith revenue antenna line;
POᵢ is the value of the prototype of the power line for the original road according to the initialization;
SNR is a signal value on noise;
NI is the value of the calculated noise power of PUSCH;
Delta₁ is the first evaluation coefficient;
Delta₂ is the second evaluation coefficient;
perform transfercard and power for each collection line as immediate if the value appears TOᵢ between the line is more than 8 units or the value POᵢ between the lines deviated over 2 dB:
for delay, it will follow the formula defined by the formula (1) for the transfercard card compensation value;
for capacity, it will follow the defined formula according to the formula (2) for the transfer card compensation value.
